(19) United States
(12) Patent Application Publication
(10) Pub. No.: US 2009/0284483 A1
(43) Pub. Date: Nov. 19, 2009

(54) Display Device and Method Having Sensing Function

(75) Inventors: Yu-Hsin Ting, Hsinchu (TW); Chee-Wai Lau, Hsinchu (TW); Ming-Tien Lin, Hsinchu (TW); Chung-Lung Li, Hsinchu (TW); Heng-Sheng Chou, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/255,878

(22) Filed: Oct. 22, 2008

(30) Foreign Application Priority Data
May 15, 2008 (TW) 97117915

(51) Int. Cl. G06F 3/041

(52) U.S. Cl. 345/173

(57) ABSTRACT

A display device and method having a sensing function is described. The device includes a liquid crystal display (LCD) panel and plural sense lines. The LCD panel includes a plurality of data lines and a plurality of gate lines. Each of the data lines is connected electrically to a plurality of left pixels and a plurality of right pixels. The sense line is disposed between each two adjacent data lines, and each of the sense lines is configured to be parallel to the data lines and perpendicular to the gate lines. The sense lines are used to transmit touch signals.

### CROSS-REFERENCES TO RELATED APPLICATIONS

This non-provisional application claims priority under 35 U.S.C. §119(a) on Patent Application No. 97117915 filed in Taiwan, R.O.C. on May 15, 2008, the entire contents of which are hereby incorporated by reference.

### BACKGROUND OF THE INVENTION

1. Field of the Invention

The present invention relates to a display device and method, and more particularly to a display device and method having a sensing function.

2. Related Art

Touch panels have been widely accepted by more and more consumers, since they can be operated in an intuitive way, and have gradually become popular electronic products. Accordingly, conventional liquid crystal display (LCD) panels can have additional value if the original LCD panels are provided with the sensing function of touch panels.

In the conventional art, an LCD panel having a touch sensing function includes a plurality of gate lines, data lines, and sensing elements. The gate lines and the data lines are disposed in an interlaced mode. Gate lines are used to transmit an operating signal to turn on control switches electrically connected to the gate lines, such that a data voltage transmitted by the data lines enters the conducted gate lines and charges the liquid crystal molecules. Thus, the pixels can display correct color levels. In addition, in order to turn a conventional LCD panel into a touch panel, the sensing elements are disposed evenly on the LCD panel to transmit touch signals.

However, “brightness” is one of the most important specifications of an LCD display, determined mainly by an aperture ratio. In a conventional touch panel, many sensing elements are disposed on the panel to enhance the touch sensing function. As the areas where the sensing elements are disposed cannot be configured as completely light transmissive, the aperture ratio of the LCD display is reduced greatly, and accordingly, the brightness of the LCD display is also significantly reduced.

Therefore, it has become an urgent problem to be solved to improve the design of the conventional LCD display to provide the touch sensing function while maintaining the original performance of the LCD display.

### SUMMARY OF THE INVENTION

Accordingly, the present invention is directed to a display device having a sensing function. The device includes a liquid crystal display (LCD) panel and plural sense lines. The LCD panel includes a plurality of data lines and a plurality of gate lines. Each of the data lines is electrically connected to a plurality of left pixels and a plurality of right pixels. The sense line is disposed between each two adjacent data lines, and each of the sense lines is configured to be parallel to the data lines and perpendicular to the gate lines. The sense lines are used to transmit touch signals.

The present invention is also directed to a display method having a sensing function. The method includes the following steps of providing a liquid crystal display (LCD) panel having a plurality of data lines and a plurality of gate lines, and disposing a plurality of sense lines between each two adjacent data lines, in which each of the data lines is connected electrically to a plurality of left pixels and a plurality of right pixels, and each of the sense lines is configured to be parallel to the data lines and perpendicular to the gate lines.

Preferred embodiments of the present invention and their effects are further described below with reference to the accompanying drawings.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic view of a display device having a sensing function according to a first embodiment of the present invention;

FIG. 2 is a schematic view of a display device having a sensing function according to a second embodiment of the present invention;

FIG. 3 is a schematic view of a display device having a sensing function according to a third embodiment of the present invention; and

FIG. 4 is a flow chart of a display method having a sensing function.

### DETAILED DESCRIPTION OF THE INVENTION

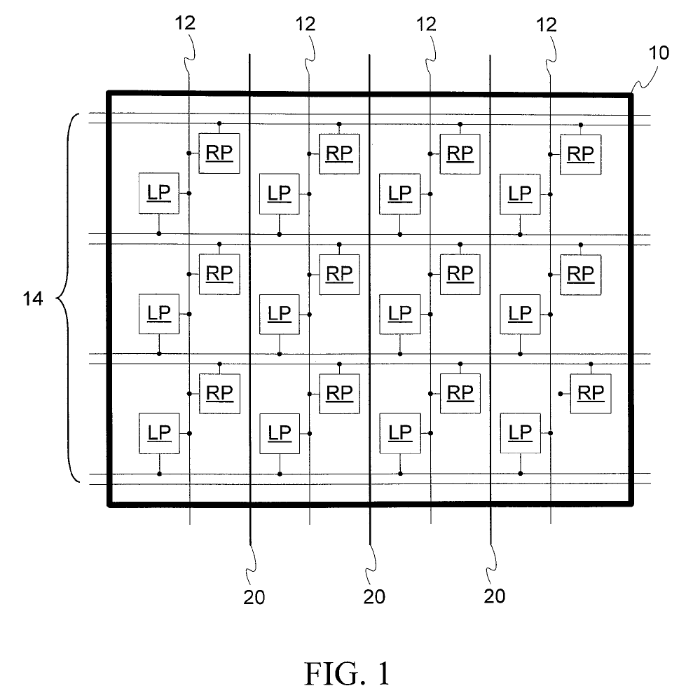

FIG. 1 is a schematic view of a display device having a sensing function according to a first embodiment of the present invention. Referring to FIG. 1, the display device having a sensing function of the present invention includes a liquid crystal display (LCD) panel 10 and sense lines 20.

The LCD panel 10 includes a plurality of data lines 12 and a plurality of gate lines 14. Each of the data lines 12 is electrically connected to a plurality of left pixels LP and a plurality of right pixels RP.

The plurality of sense lines 20 is disposed between each two adjacent data lines 12. Each of the sense lines is configured to be parallel to the data lines 12 and perpendicular to the gate lines 14. The sense lines 20 are used to transmit touch signals.

The LCD panel 10 of the present invention is of the following type: it is assumed that the LCD panel has M*2N pixels, and correspondingly, the LCD panel 10 has an total of N data lines 12 and 2M gate lines 14, where M and N are both positive integers. That is, in the original configuration 2N data lines 12 are connected electrically to the left pixels LP and right pixels RP respectively, while in the present invention one data line 12 is used to control the left pixels LP and the right pixels RP. Therefore, fewer data lines 12 are needed. The original spaces for configuring the data lines 12 still exist, and belong to areas that have not yet been wired in the LCD panel 10. In the present invention, the sense lines 20 are disposed in the areas that have not yet been wired, that is, the areas between each two adjacent data lines 12. Thus the original spaces that have not yet been wired are fully utilized, and the LCD panel 10 is able to have a sensing function similar to a touch panel without requiring any additional space for disposing the sense lines.

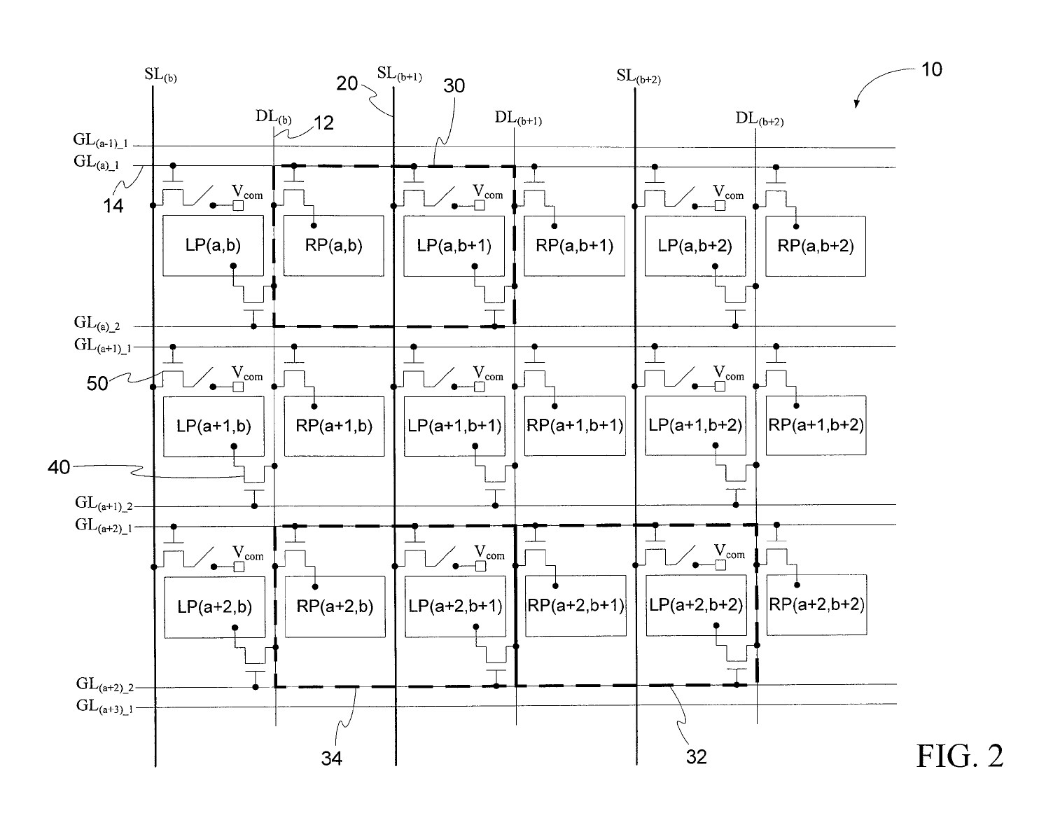

FIG. 2 is a schematic view of a display device having a sensing function according to a second embodiment of the present invention. The architecture of the present invention can be understood in a better way with reference to FIG. 2. The connection relations between the elements in the display device having a sensing function of the present invention will be described below in more detail.

The LCD panel 10 includes a plurality of pixel areas 30. Each of the pixel areas 30 is located between adjacent data lines (DL) 12 and adjacent gate lines (GL) 14, and includes a left pixel LP and a right pixel RP. It may be seen from FIG. 2 that the left pixel LP and right pixel RP of the pixel area 30 are connected electrically to adjacent data lines 12.

Referring to FIG. 2, among the pixel areas 30, a first pixel area 32 and a second pixel area 34 sharing a common gate line 14 are included. The first pixel area 32 and the second pixel area 34 are disposed adjacent to each other. Each of the data lines 12 is connected electrically to the right pixel RP of the first pixel area 32 and the left pixel area LP of the second pixel area 34.

The pixel areas 30 include a plurality of control switches 40 connected electrically to the gate lines 14 and the data lines 12. The control switch 40 of the left pixel LP of the pixel area 30 and the control switch 40 of the right pixel RP of the pixel area 30 are connected electrically to adjacent gate lines 14.

As described above, the LCD panel 10 of the present invention has totally N data lines 12 and 2M gate lines 14. As the sense lines 20 are used to transmit touch signals, the number of the configured sense lines 20 can be changed according to the sensing function required by the LCD panel 10. When the LCD panel 10 requires a high sensing capability, more sense lines 20 may be used. Conversely, when the LCD panel 10 requires a low sensing capability, fewer sense lines 20 may be used to reduce the cost. Therefore, the number of the disposed sense lines 20 lies within a range between 1 and N.

In addition, the present invention further includes a plurality of sensing switches 50 disposed at junctions between the sense lines 20 and the gate lines 14. Each of the sensing switches 50 is coupled to the sense line 20 and the gate line 14 correspondingly. It may be seen from FIG. 2 that the sensing switches 50 are disposed in the pixel areas 30. Similar to a common touch panel, when a point on the touch panel is pressed the corresponding sensing switch 50 is conducted with a common voltage V_{com}. At this time, as long as the gate line 14 coupled to the sensing switch 50 provides an operating signal to turn on the sensing switch 50, a touch signal enters the sense line 20 coupled to the sensing switch 50 via the sensing switch 50, so as to effect the touch sensing function. The number of the sensing switches 50 is determined according to the required sensing density. In FIG. 2 it is assumed that the LCD panel 10 has M rows, so a single sense line 20 is connected with M sensing switches 50. Here the number of the disposed sensing switches 50 is in a range between 1 and M.

Furthermore, the data lines 12 can transmit video signals from an application-specific integrated circuit (ASIC). Therefore, the data lines 12 must provide data voltages required by the display of the pixels. The sense lines 20 may also be connected to the ASIC, without providing the data voltages required by the display of the pixels.

The concept of the aperture ratio in the LCD display is described briefly as follows. One important specification of the LCD display is brightness, and the most important factor that determines the brightness is the aperture ratio. In simple terms, the aperture ratio is a ratio of an effective area which light can penetrate. When light is emitted from a backlight plate, not all of the light penetrates the panel. For example, light cannot penetrate completely through the signal wires of LCD driving chips, TFT, and storage capacitors for storing voltage, and the light penetrating through these areas cannot be controlled by the voltage, such that the correct grayscale cannot be displayed. Therefore, a black matrix must be used to shield these areas to avoid interfering with the correct brightness of the other areas where the light can penetrate. The ratio of the area where the light can effectively penetrate to the total area is the aperture ratio.

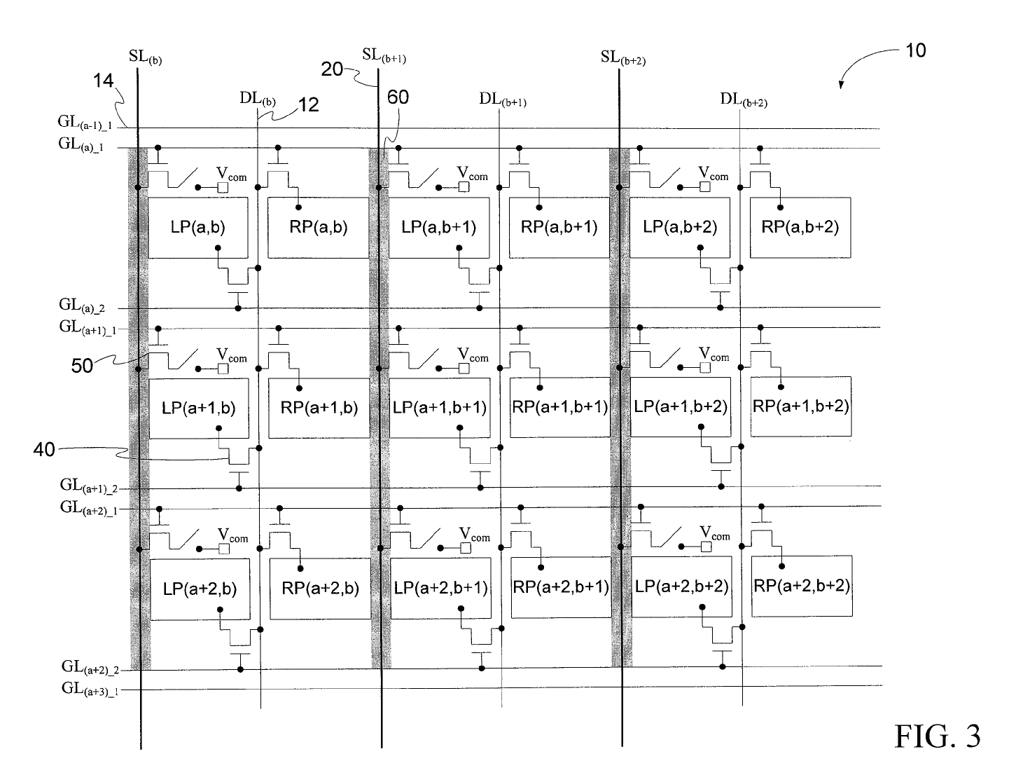

FIG. 3 is a schematic view of a display device having a sensing function according to a third embodiment of the present invention. Referring to FIG. 3, the pixel areas 30 in the third embodiment further include black matrixes 60. The black matrixes 60 overlap the sense lines 20. In other words, just like the position of the sense line 20, each of the black matrixes 60 is located between two pixels controlled by adjacent data lines 12, that is, in an area that has not yet been wired. In practice, the areas that have not been wired are shielded by the black matrixes 60 so as to avoid interfering with the correct brightness of the other areas where the light can penetrate. Therefore, the black matrixes 60 overlap the sense lines 20, that is, they are shielded by the black matrixes 60 even if the areas that have not been wired yet are not configured for disposing the sense lines 20. Even if the sense lines 20 are disposed in the areas that have not yet been wired in the present invention, the aperture ratio of the entire LCD panel 10 is almost unchanged.

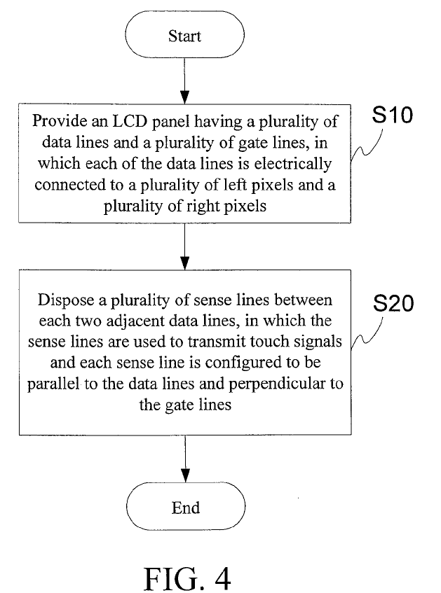

FIG. 4 is a flow chart of a display method having a sensing function. The method includes the following steps.

In Step S10, an LCD panel having a plurality of data lines and a plurality of gate lines is provided. Each of the data lines is electrically connected to a plurality of left pixels and a plurality of right pixels.

In Step S10, the step of providing the LCD panel further includes disposing a plurality of pixel areas between adjacent data lines and adjacent gate lines, in which each of the pixel area includes a left pixel and a right pixel.

Considering the disposed pixel areas, the following steps are included.

A left pixel and a right pixel of a pixel area are connected electrically to adjacent data lines.

A first pixel area and a second pixel area sharing a common gate line are disposed among the pixel areas, in which the first pixel area and the second pixel area are disposed adjacent to each other. Each data line is connected electrically to the right pixel of the first pixel area and the left pixel of the second pixel area.

A plurality of control switches is disposed in the pixel areas and connected electrically to the gate lines and the data lines. The control switch of the left pixel in the pixel area and the control switch of the right pixel in the pixel area are connected electrically to adjacent gate lines.

Black matrixes overlapping the sense lines are disposed in the pixel areas.

In Step S20, the plurality of sense lines 20 for transmitting touch signals is disposed between each two adjacent data lines 12, where each of the sense lines is configured parallel to the data lines and perpendicular to the gate lines.

The LCD panel provided in Step S10 may have M*2N pixels. Here, the following steps are further included: setting a total number of the data lines as N and setting a total number of the gate lines as 2M. M and N are both positive integers.

As for the above LCD panel having M*2N pixels, the following steps are included.

A total number of the sense lines is allocated in a range between 1 and N. A plurality of sensing switches is disposed at junctions between the sense lines and the gate lines. Each of the sensing switches is coupled to a sense line and a gate line correspondingly. The sensing switches are disposed in the pixel areas. A total number of the sensing switches is allocated in a range between 1 and M.

Finally, as for the disposed sensing switches, the following steps are included. A sensing switch receives an operating signal generated by the gate line coupled to the sensing switch; and a trigger signal enters the sense line coupled to the sensing switch according to the operating signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device having a sensing function, comprising:
a liquid crystal display (LCD) panel, comprising a plurality of data lines and a plurality of gate lines, wherein each of the data lines is connected electrically to a plurality of left pixels and a plurality of right pixels; and
a plurality of sense lines, disposed between each two adjacent data lines, wherein each of the sense lines is configured parallel to the data lines and perpendicular to the gate lines, and the sense lines are used to transmit touch signals.

2. The display device having a sensing function according to claim 1, wherein the LCD panel comprises:
a plurality of pixel areas, located between adjacent data lines and adjacent gate lines, wherein each of the pixel areas comprises a left pixel and a right pixel.

3. The display device having a sensing function according to claim 2, wherein the left pixel and the right pixel of the pixel area are connected electrically to adjacent data lines.

4. The display device having a sensing function according to claim 2, wherein the pixel areas comprise a first pixel area and a second pixel area sharing the common gate line, the first pixel area and the second pixel area are disposed adjacent to each other, and each of the data lines is connected electrically to a right pixel of the first pixel area and a left pixel of the second pixel area.

5. The display device having a sensing function according to claim 2, wherein each of the pixel areas comprises a plurality of control switches connected electrically to the gate lines and the data lines, and the control switch of the left pixel of the pixel area and the control switch of the right pixel of the pixel area are connected electrically to adjacent gate lines.

6. The display device having a sensing function according to claim 2, wherein each of the pixel areas further comprises a black matrix overlapping the sense lines.

7. The display device having a sensing function according to claim 2, wherein the LCD panel comprises M*2N pixels, a total number of the data lines is N, a total number of the gate lines is 2M, and M and N are both positive integers.

8. The display device having a sensing function according to claim 7, wherein a total number of the sense lines is allocated in a range between 1 and N.

9. The display device having a sensing function according to claim 7, further comprising: a plurality of sensing switches, disposed at junctions between the sense lines and the gate lines, wherein each of the sensing switches is coupled to the sense line and the gate line correspondingly.

10. The display device having a sensing function according to claim 9, wherein the sensing switches are disposed in the pixel areas.

11. The display device having a sensing function according to claim 9, wherein a total number of the sensing switches is allocated in a range between 1 and M.

12. The display device having a sensing function according to claim 9, wherein whether the touch signal enters the sense line via the sensing switch coupled to the sense line or not is determined by an operating signal provided by the gate line coupled to the sensing switch.

13. A display method having a sensing function, comprising:
providing a liquid crystal display (LCD) panel having a plurality of data lines and a plurality of gate lines, wherein each of the data lines is connected electrically to a plurality of left pixels and a plurality of right pixels; and
disposing a plurality of sense lines between each two adjacent data lines, wherein the sense lines are used for transmitting touch signals, and each of the sense lines is configured to be parallel to the data lines and perpendicular to the gate lines.

14. The display method having a sensing function according to claim 13, wherein the step of providing the LCD panel further comprises:
disposing a plurality of pixel areas between adjacent data lines and adjacent gate lines, wherein each of the pixel areas comprises a left pixel and a right pixel.

15. The display method having a sensing function according to claim 14, further comprising:
connecting electrically the left pixel and the right pixel of the pixels area to adjacent data lines.

16. The display method having a sensing function according to claim 14, further comprising:
disposing a first pixel area and a second pixel area sharing a common gate line in the pixel areas, wherein the first pixel area and the second pixel area are disposed adjacent to each other; and
connecting electrically each of the data lines to a right pixel of the first pixel area and a left pixel of the second pixel area.

17. The display method having a sensing function according to claim 14, further comprising:
disposing a plurality of control switches in the pixel areas; and
connecting electrically the control switches to gate lines and data lines;
wherein the control switch of the left pixel of the pixel area and the control switch of the right pixel of the pixel area are connected electrically to adjacent gate lines.

18. The display method having a sensing function according to claim 14, further comprising:
disposing a black matrix overlapping the sense lines in each of the pixel areas.

19. The display method having a sensing function according to claim 14, wherein the step of providing the LCD panel further comprises:
allocating a total number of data lines to N; and
allocating a total number of gate lines to 2M;
wherein M and N are both positive integers, and the LCD panel comprises M*2N pixels.

20. The display method having a sensing function according to claim 19, wherein the step of disposing the sense lines further comprises:
allocating a total number of the sense lines in a range between 1 and N.

21. The display method having a sensing function according to claim 19, further comprising:
disposing a plurality of sensing switches at junctions between the sense lines and the gate lines, wherein each of the sensing switches is coupled to the sense line and the gate line correspondingly.

22. The display method having a sensing function according to claim 21, wherein the step of disposing the sensing switches further comprises:
disposing the sensing switches in the pixel areas.

23. The display method having a sensing function according to claim 21, wherein the step of disposing the sensing switches further comprises:
allocating a total number of the sensing switches in a range between 1 and M.

24. The display method having a sensing function according to claim 21, further comprising:
receiving a turn-on signal generated by a gate line coupled to the sensing switch by the sensing switch; and
transferring the trigger signal to the sense line via the sensing switch coupled to the sense line according to the operating signal.
